(19) United States
(12) Patent Application Publication
(10) Pub. No.: US 2004/0140382 A1
(43) Pub. Date: Jul. 22, 2004

(54) Paper shredder

(76) Inventor: Ming Hui Ho, Hsin Chuang City (TW)

Correspondence Address: BACON & THOMAS, PLLC, 625 SLATERS LANE, FOURTH FLOOR, ALEXANDRIA, VA, 22314

(21) Appl. No.: 10/346,132

(22) Filed: Jan. 17, 2003

(51) Int. Cl. B02C 18/16

(52) U.S. Cl. 241/236

(57) ABSTRACT

A paper shredder has two rotary cutters driven by a deceleration device and a casing encased the two rotary cutters and the decelerating device and having a paper track defined between the two paper guides and cashing to allow the stuck paper to be directed directly into the can mounted below the two rotary cutters without damaging any mechanism.

### BACKGROUND OF THE INVENTION

1. Field of the Invention

The present invention is a paper shredder, and more particularly is a paper shredder having guiding slots defined between first and second paper guides on two rotary cutters so as to eliminate the blockage by the shredded paper. A casing is provided to enclose the motor and the driving mechanism to prevent shredded paper from falling into the motor or the driving mechanism and thus causing a malfunction.

2. Description of the Related Art

A conventional paper shredder, as in U.S. Pat. Nos. 5,354,001, 3,724,766, 5,893,524, 4,913,360. When operated, will automatically have the shredded paper fallen into the trash can. However, having the shredded paper fallen into the trash can, the motor of the paper shredder needs to rotate in a reversed direction so as to allow the shredded paper to escape from the rotary cutters to smoothly fall into the trash can, which allows a small amount of shredded paper stuck in the shredder. When the amount of shredded paper increases, the paper shredder will not function normally. Thus a user will have to disassemble the paper shredder to clean the shredded paper to resume the function of the paper shredder. Furthermore, the rotary cutters of the conventional paper shredder are exposed directly to the outside of the shredder, which not only affects the overall appearance, but also easily causes malfunction to the mechanism due to the fallen dust and objects.

The present invention provides an improved paper shredder to overcome the above mentioned shortcomings.

### SUMMARY OF THE INVENTION

The primary objective of the invention is to provide an improved paper shredder to allow the shredded paper to fall into the trash can directly without blockage the function of the mechanism.

Another objective of the invention is to provide a blocking device in the entry of the paper shredder to prevent any undesired objects from falling into the paper shredder to malfunction any mechanism in the machine.

Still another objective of the invention is to provide an improved paper shredder having a first and a second paper guides on the two rotary cutters of the paper shredder so as to guide the shredded paper easily.

Still another objective of the invention is that each of the first and the second paper guides have an identification hole, such that the user is able to quickly and easily assemble the rotary cutters on the paper shredder.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the main body of the paper shredder constructed in accordance with the present invention;

FIG. 2 is a perspective view of the paper shredder of FIG. 1;

FIG. 3 is a schematic side view of the paper shredder of the invention;

FIG. 4 is a partial enlarged schematic view showing the mounting of a blocking device mounted on top of two rotary cutters of the invention;

FIG. 5 is a perspective view of the rotary cutters of the present invention;

FIG. 6 is a cross sectional view of the paper guides mounted on the axle; and

FIG. 7 is a cross sectional view of the paper guides together with the pads of the present invention.

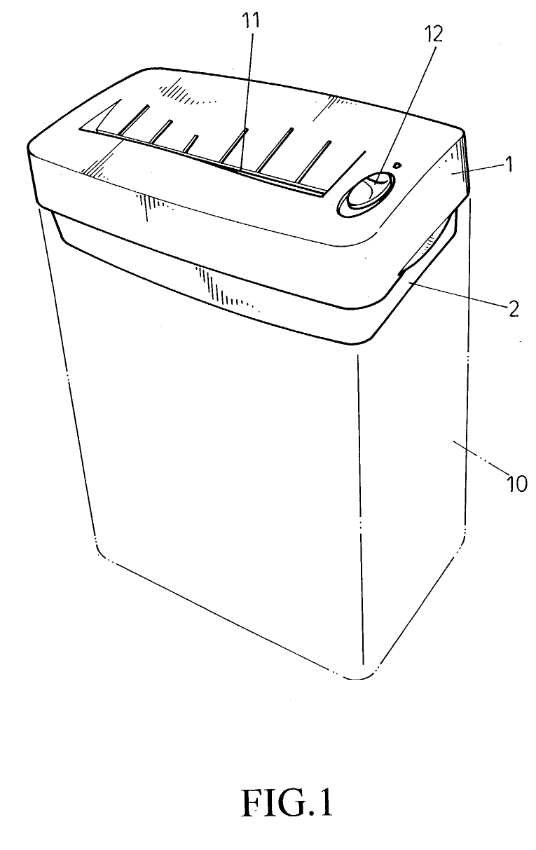

### DETAILED DESCRIPTION OF THE PREFERRED EMBODIMENTS

With reference to the figures, a paper shredder or the invention has a top cover 1, a base 2 and a can 10.

The top cover 1 has an entrance 11 defined to allow the entrance of waste paper and a switch 12 mounted to connect with circuits (not shown) to control the operation of the paper shredder.

The base 2 is provided to securely accommodate a motor 3, a decelerating device 4, two rotary cutters 5, 6 and two paper guides 7, 7′.

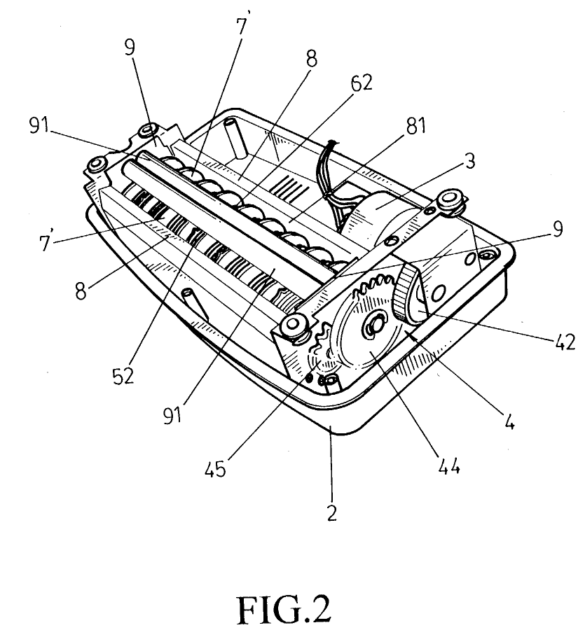

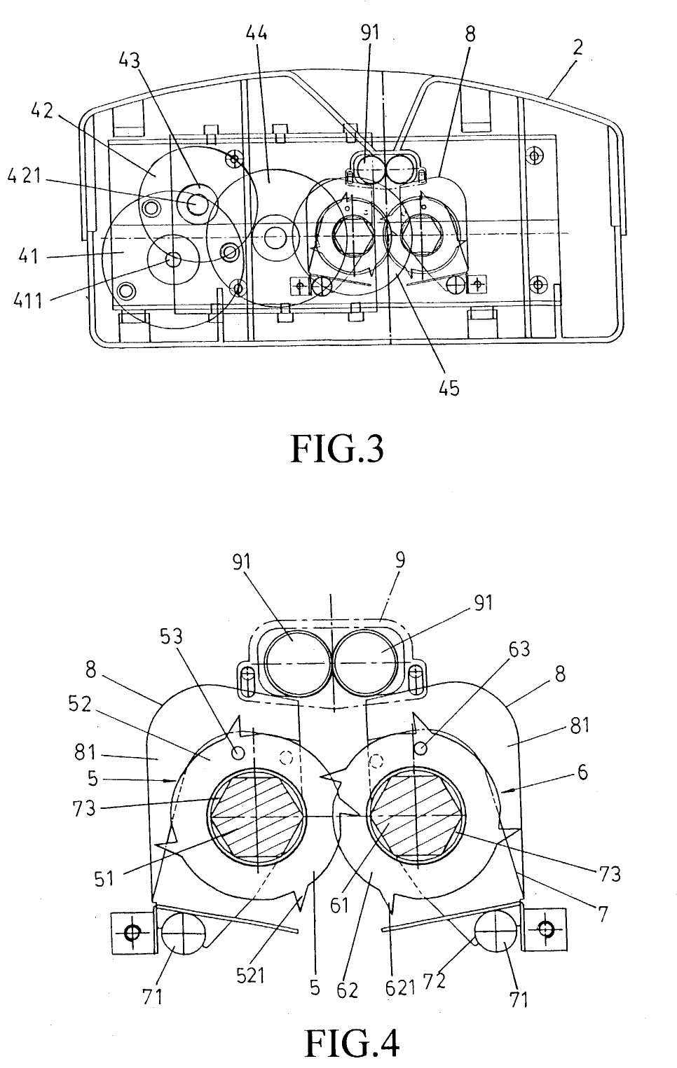

The motor 3 is connected with the switch 12 by means of wires such that the switch 12 is able to control the operation of the motor 3. The motor 3 drives the motion of the decelerating device 4. In the preferred embodiment of the invention as shown in FIGS. 2 and 3, the shaft of the motor 3 is mated with the shaft 41 of the first gear 41 and the shaft 411 of the first gear 41 is mated with a second gear 42. The shaft 421 of the second gear 42 is mated with a small gear 43 and the small gear 43 is mated with a big gear 44. The big gear 44 is then mated with two gears 45. The two gears 45 are respectively engaged with shafts 51, 61 of two rotary cutters 5, 6. In this arrangement, the two rotary cutters 5, 6 each have a first and a second blades 52, 62 alternately mounted with each other and are driven to rotate by the decelerating device 4. The two paper guides 7, 7′ extend out from each of the first and the second blades 52, 62. Each of the paper guides 7, 7′ correlates with each other in such a manner that when the paper is shredded, both paper guides 7, 7′ will help to push the shredded paper to a desired direction.

With reference to FIGS. 2 and 4, the two rotary cutters 5, 6 are rotatably mounted in the U-shaped casing 8. Each of the two rotary cutters 5, 6 consists of two secondary cutters 52, 62 and every secondary cutter 52, 62 has multiple cutting edges 521, 621. A paper track 81 is then defined between the two paper guides 7, 7′ and cashing 8. Such that when the volume of the paper to be shredded is too large and the rotary cutters 5, 6 are stuck, a reverse rotation of the rotary cutters 5, 6 will drive the jammed paper into the paper track 81. The jammed paper will then still fall into the can 10. Furthermore, the second paper guide 7′ isolates the rotary cutters 5, 6 from the decelerating device 4 and the motor 3 so as to avoid malfunction caused by the jammed paper when being driven by the reverse rotation of the rotary cutters 5, 6.

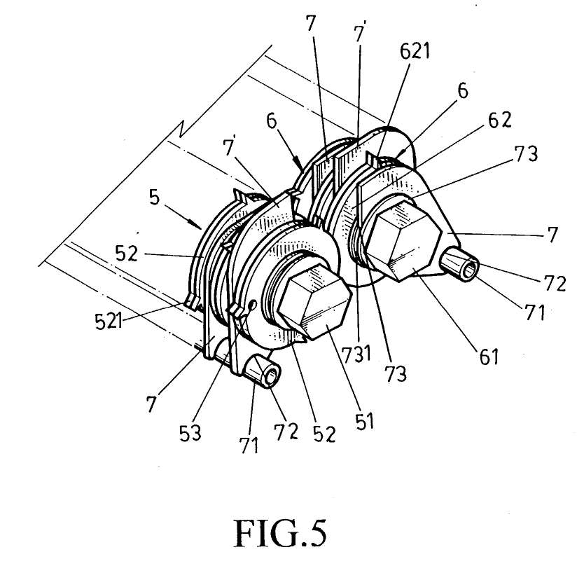

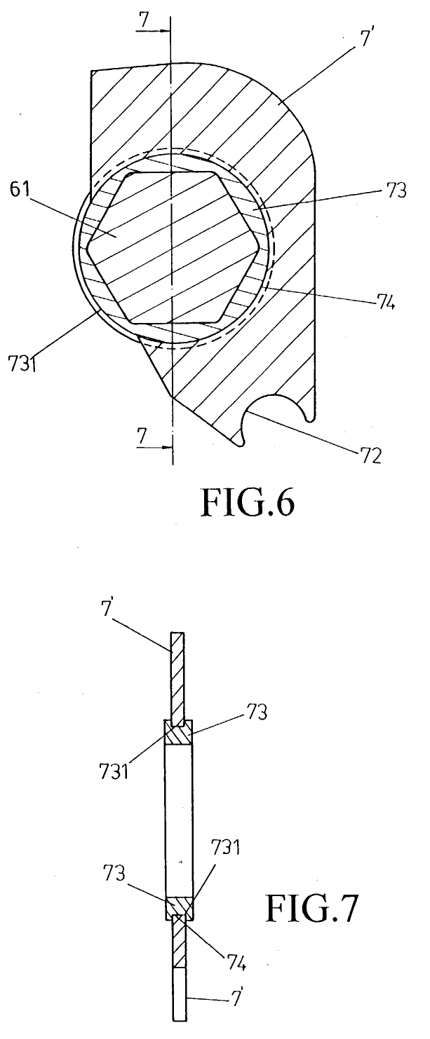

Referring again to FIGS. 3, 4 and 5, a tube 71 is respectively mounted under the two rotary cutters 5, 6 such that notches 72 of each of the paper guides 7, 7′ mate with the tube 71 and the paper guides 7, 7′ are then secured. A washer 73 is respectively secured on the shafts 51, 61 of the two rotary cutters 5, 6 and has a cutout 731 defined to correspond to an edge 74 of the paper guide 7′, as shown in FIGS. 6 and 7.

It is to be noted that a seat 9 is mounted on top of the casing 8 and having two cylinders 91 closely engaged with each other. The joint between the two cylinders 91 corresponds to the entrance 11 of the top cover 1. The two cylinders 91 are spring-biased such that when a paper is to be shredded, the user insets the paper into the entrance 11 and the paper will slit through the joint of the two cylinders 91. With the provision of the two cylinders 91, dust and alien objects are prevented to fall into the mechanism to cause any damage.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A paper shredder comprising:
a top cover with an inlet to receive waste paper,
a base to which said top cover is attached,
a motor to power a drive mechanism,
two rotary cutters engaged with each other, each said rotary cutter having multiple integrally formed blades and at least two paper guides to direct paper in a desired direction, said paper guides being positioned between said blades of said rotary cutters and extending above said rotary cutters so that paper is guided between said paper guides.
a casing encasing said rotary cutters, said motor, and said drive mechanism, and
a can mounted below the top cover to receive shredded paper; wherein
a paper track is defined between said paper guides and said casing, said paper track being aligned with said inlet on top cover,
said rotary cutters being driven by said drive mechanism so as to shred paper in said paper track there between, and
said paper guides direct shredded and unshredded paper into said can.

2. The paper shredder as claimed in claim 1, wherein:
a seat is mounted inside of said top cover and aligned with said inlet, said seat having two spring-biased cylinders engaged with each other, a joint between said two cylinders being a part of said paper track.

3. The paper shredder as claimed in claim 1, wherein:
Each of said rotary cutters comprises at least two secondary cutters, each said secondary cutter having and identification hole.

4. The paper shredder as claimed in claim 2, wherein:
each of said rotary cutters comprises at least two secondary cutters, each said secondary cutter having an identification hole.

5. The paper shredder as claimed in claim 1, wherein:
a bushing is provided to secure elements on a shaft supporting each of said two rotary cutters, and cutouts are defined in said bushing to correspond to edges of each of said two paper guides.

6. The paper shredder as claimed in claim 2, wherein:
a bushing is provided to secure elements on a shaft supporting each of said two rotary cutters, and cutouts are defined in said bushing to correspond to edges of each of said two paper guides.

7. The paper shredder as claimed in claim 3, wherein:
a bushing is provided to secure elements on a shaft supporting each of said two rotary cutters, and cutouts are defined in said bushing to correspond to edges of each of said two paper guides.

8. The paper shredder as claimed in claim 4, wherein:
a bushing is provided to secure elements on a shaft supporting each of said two rotary cutters, and cutouts are defined in said bushing to correspond to edges of each of said two paper guides.
